(19) United States
(12) Patent Application Publication
(10) Pub. No.: US 2015/0323303 A1
(43) Pub. Date: Nov. 12, 2015

(54) CALCULATION APPARATUS, PHASE VALUE OBTAINING SYSTEM, AND PHASE IMAGE OBTAINING METHOD

(71) Applicant: CANON KABUSHIKI KAISHA, Tokyo (JP)

(72) Inventor: Takeshi Kondoh, Kawasaki-shi (JP)

(21) Appl. No.: 14/704,159

(22) Filed: May 5, 2015

(30) Foreign Application Priority Data
May 8, 2014 (JP) 2014-097149

(51) Int. Cl. G01B 9/02

(52) U.S. Cl. CPC G01B 9/02083; G01B 9/0201

(57) ABSTRACT

A calculation apparatus that integrates a differential phase image and obtains a phase image includes a weighting unit and an integration unit. The weighting unit performs weighting of a differential phase image that has a plurality of differential phase values, each of the differential phase values being obtained by using intensity information of a plurality of pixels included in one intensity distribution formed by a differential interferometer, and obtains a weighted differential phase image. The integration unit integrates the weighted differential phase image and obtains a phase image. The weighting unit performs weighting of the differential phase values in accordance with a position in the differential phase image, such that at least a part of differential phase values in end parts of the differential phase image is weighted more lightly than a differential phase value in a central part of the differential phase image.

### BACKGROUND OF THE INVENTION

1. Field of the Invention

The present invention generally relates to image processing, and in particular it relates to a calculation apparatus that obtains a phase image, a phase value obtaining system, and a method of obtaining a phase image.

2. Description of the Related Art

A differential interferometer (also referred to as Shearing interferometer) is an optical system that divides coherent light emitted from a light source into a first light beam having one wavefront and a second light beam having another wavefront, generates a distortion caused by a subject on the one wavefront, slightly shifts the other wavefront to form a periodic intensity distribution (so-called interference image) to be detected. A phase change of the light caused by the subject can be obtained from a change of this intensity distribution. Instead of visible light, an electromagnetic wave such as an X-ray other than the light can be used, or an electron beam can also be used. It is noted that the periodic intensity distribution is not limited to an intensity distribution in which a period in the intensity distribution is constant. For example, even when an intensity distribution has a changing period that becomes larger or smaller towards the center of the intensity distribution, as long as a bright section and a dark section are arranged in the intensity distribution, this intensity distribution is regarded as a periodic intensity distribution.

As one of methods of obtaining information related to the phase change of the light caused by the subject (that is, phase information of the subject) from the change of the intensity distribution, that is, one of phase retrieval methods, a Fourier transform method as described in M. Takeda, et al. “Fourier-transform method of fringe pattern analysis for computer-based topography and interferometry”, J. Opt. Soc. Am., 72 (1982) 156-160 has been proposed. The Fourier transform method is a method of performing Fourier transform of the intensity distribution to obtain the phase change amount of the intensity distribution from information of a periphery of a spectrum matched with its carrier frequency.

In the case of the differential interferometer, the phase change amount of the intensity distribution is a value obtained by differentiating the phase change amount of the light caused by the subject. Thus, it is possible to obtain the phase change amount of the light caused by the subject by integrating the phase change amount of the intensity distribution obtained by a phase retrieval. It is noted that each of the values obtained by differentiating the phase change amount of the light caused by the subject is referred to as “a differential phase value”, a spatial distribution of the differential phase value is referred to as differential phase image; each of the phase change amounts of the light caused by the subject is referred to as “a phase value”, and a spatial distribution of the phase value is referred to as phase image in the present specification.

Several methods have been proposed as a method of obtaining the phase image by integrating the differential phase image. For example, it is possible to obtain the phase image by sequentially accumulating the differential phase values of the differential phase image.

### SUMMARY OF THE INVENTION

A calculation apparatus according to an aspect of the present invention relates to a calculation apparatus that integrates a differential phase image and obtains a phase image, the calculation apparatus including a weighting unit that performs weighting of a differential phase image that has a plurality of differential phase values, each of the differential phase values being obtained by using intensity information of a plurality of pixels included in one intensity distribution formed by a differential interferometer, and obtains a weighted differential phase image; and an integration unit that integrates the weighted differential phase image and obtains a phase image, in which the weighting unit performs weighting of the differential phase values in accordance with a position in the differential phase image, and performs weighting of at least a part of differential phase values in end parts of the differential phase image more lightly than a differential phase value in a central part of the differential phase image.

Further features of the present invention will become apparent from the following description of exemplary embodiments with reference to the attached drawings.

### BRIEF DESCRIPTION OF THE DRAWINGS

FIGS. 1A to 1C are functional block diagrams of a calculation apparatus according to an exemplary embodiment of the present invention and a process chart of an obtaining method performed by the calculation apparatus.

FIG. 2 is an explanatory diagram for describing an outline of a first exemplary embodiment.

FIG. 3 is an explanatory diagram for describing an outline of a second exemplary embodiment.

FIGS. 4A to 4H illustrate a subject used for a simulation according to Comparison Examples 1 and 2 and Examples 1 to 4.

FIGS. 5A and 5B illustrate a periodic pattern used in the simulation according to Comparison Examples 1 and 2 and Examples 1 to 4.

FIGS. 6A to 6F illustrate a differential phase image obtained according to Comparison Example 1.

FIGS. 7A to 7H illustrate a weighted differential phase image and a phase image obtained according to Example 1.

FIGS. 8A to 8H illustrate a weighted differential phase image and a phase image obtained according to Example 2.

FIGS. 9A to 9H illustrate a weighted differential phase image and a phase image obtained according to Example 3.

FIGS. 10A to 10H illustrate a weighted differential phase image and a phase image obtained according to Example 4.

FIGS. 11A to 11D illustrate a filter used according to Comparison Example 2 and Examples 3 and 4.

FIGS. 12A and 12B illustrate a phase image obtained according to Comparison Example 1.

FIGS. 13A to 13H illustrate a differential phase image and a phase image obtained according to Comparison Example 2.

FIG. 14 is a schematic view of a Talbot-Lau interferometer according to the first to fourth exemplary embodiments.

### DESCRIPTION OF THE EMBODIMENTS

To obtain phase change amounts of the intensity distributions in the respective pixels, intensity information of a peripheral pixel of the relevant pixel is also used in the Fourier transform method. In this manner, when the intensity information of the peripheral pixel of the relevant pixel is also used to obtain the phase change amounts of the intensity distributions in the respective pixels, differential phase values in the respective pixels may not be correctly obtained in end parts of the intensity distribution in some cases. This is because a part of data of the peripheral pixel to be used is insufficient in the end part of the intensity distribution. Since analyzed data is assumed to have a periodicity according to the Fourier transform method, for example, to obtain the differential phase value in the pixel in a right end part of the intensity distribution, the intensity information of the pixel in a left end part of the intensity distribution is also used. In this manner, it can be understood that an accuracy of the differential phase value is decreased with regard to the differential phase value obtained by using the intensity information of discontinuous pixels as compared with the differential phase value obtained by using only the intensity information of continuous pixels. The same applies to methods other than the Fourier transform method as long as the method includes using the intensity information of a plurality of pixels to obtain the differential phase value for one pixel.

On the other hand, the phase image is obtained by integrating the differential phase image. If the differential phase values of the respective pixels of the differential phase image are deviated from correct values, the deviated values are accumulated in the integrated image. Thus, an influence of the decrease in the accuracy of the differential phase values in the end parts of the intensity distribution may be extensively spread in the phase image in some cases.

In view of the above, according to the respective exemplary embodiments which will be described below, a calculation apparatus that obtains the phase image by integrating the differential phase image in which each of the differential phase values is obtained by using the intensity information of the plurality of pixels and can decrease the influence of the decrease in the accuracy of the differential phase values in the phase image will be described.

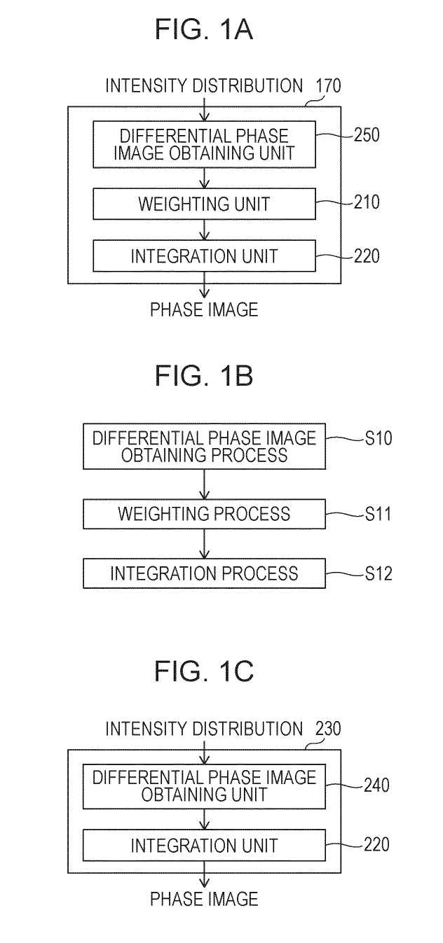

Hereinafter, the first to fourth exemplary embodiments will be described by using the drawings. FIG. 1A is a functional block diagram of a calculation apparatus according to the first to third exemplary embodiments. A calculation apparatus 170 according to the first to third exemplary embodiments is constituted by a differential phase image obtaining unit 250 that obtains a differential phase image (spatial distribution of differential phase values), a weighting unit 210, and an integration unit 220.

The differential phase image obtaining unit 250 receives an input of an intensity distribution and performs a phase retrieval by using the intensity distribution to obtain a differential phase image. The differential phase image obtaining unit 250 then outputs the differential phase image to the weighting unit 210. Each of the differential phase values of the obtained differential phase image is obtained by using intensity information of a plurality of pixels included in one intensity distribution. In a case where the phase retrieval is performed by using a plurality of intensity distributions, it is sufficient when at least one intensity distribution for which the intensity information of a plurality of pixels is used exists. For example, in a case where two intensity distributions are used, intensity information for two pixels of a first intensity distribution and one pixel of a second intensity distribution may be used.

The weighting unit 210 receives the input of the differential phase image to obtain the differential phase image and performs weighting of the obtained differential phase image to obtain the weighted differential phase image. Subsequently, the weighted differential phase image is output to the integration unit 220. The weighting unit 210 performs weighting of the differential phase value in accordance with a position in the differential phase image, that is, a coordinate. More specifically, the weighting unit 210 performs weighting of at least a part of the differential phase values in end parts of the input differential phase image more lightly than the differential phase value in a central part. As used herein, weighting “more lightly” refers to assigning a lower weight value (or weight coefficient) to end parts of the input differential phase image than a weight value (or weight coefficient) assigned to the differential phase value in a central part. When a value obtained by dividing a differential phase value in a certain area by the differential phase value in the central part, that is, an absolute value of a ratio of those differential phase values becomes smaller after the weighting than the absolute value before the weighting, the relevant area can be regarded as being more lightly weighted than the differential phase value in the central part. It is however noted that the end parts mentioned in the exemplary embodiments of the present invention and the present specification refer to pixels in the right end, the left end, the top end, and the bottom end of the differential phase image. For example, when the differential phase image has 512×512 pixels, 512×4−4 (overlapping portions)=2044 pixels exist in the end parts. The central part mentioned in the exemplary embodiments of the present invention and the present specification refers to a pixel having a median of the differential phase values. For example, when the differential phase image has 511×511 pixels, the central part refers to the 256-th pixel from the top, bottom, right, and left ends. In a case where the numbers of lengthwise and crosswise pixels of the differential phase image are both even numbers like 512×512 pixels, the central part refers to four pixels surrounding a central point of the differential phase image. In a case where the numbers of lengthwise and crosswise pixels are an even number and an odd number or an odd number and an even number, the central part refers to two pixels sandwiching the central point of the differential phase image. It is sufficient when the differential phase values weighted more lightly than the differential phase value in the central part include at least one differential phase value in the end part. For example, the differential phase values of the pixels adjacent to the end parts may be weighted more lightly than the central part. The differential phase values of the pixels adjacent to the end parts can be lightly weighted similarly as in the differential phase values in end parts. It is noted that the pixel mentioned herein is not a pixel of a detector but is a pixel of the differential phase image. In the exemplary embodiments of the present invention and the present specification, an area where the differential phase value is weighted more lightly than the differential phase value in the central part may be simply referred to as a first area or a lightly weighting area in some cases. A situation where the differential phase value in the lightly weighting area is weighted more lightly than the differential phase value in the central part is not limited to a situation where an absolute value of the differential phase value in the lightly weighting area is decreased. For example, the differential phase value in the lightly weighting area may be lightly weighted by increasing an absolute value of the differential phase value in the central part. In addition, a situation where the differential phase value in the lightly weighting area is weighted more lightly than the differential phase value in the central part may also include a setting of the differential phase value in the lightly weighting area as 0 and a deletion of the differential phase value itself in the lightly weighting area from the differential phase image.

A range for the light weighting may include not only the end part of the differential phase image but also its periphery. As described above, the accuracy of the differential phase values obtained by using the intensity information of the discontinuous pixels is lower than the accuracy of the differential phase values obtained by using only the intensity information of the continuous pixels as in the differential phase value in the central part. Thus, at least a part of the area where the differential phase values are obtained by using the intensity information of the discontinuous pixels is set as the lightly weighting area. The lightly weighting area preferably includes the entire area having the differential phase values obtained by using the intensity information of the discontinuous pixels. In this case, with regard to a degree of weighting, the differential phase value in an area closer to the end part in the lightly weighting area is preferably weighted more lightly than the differential phase value in an area closer to the central part. In addition, the area that is neither the central part nor the lightly weighting area is preferably weighted to a same degree as the central part. It is noted that the area that is neither the central part nor the lightly weighting area preferably includes the entire area except for the central part across the area where the differential phase value is obtained by using only the intensity information of spatially continuous pixels. In addition, the area that is neither the central part nor the lightly weighting area may include a part of the area where the differential phase values are obtained by using the intensity information of the discontinuous pixels. That is, at least a part of the differential phase values obtained by using the intensity information of the discontinuous pixels is preferably weighted more lightly than the differential phase value obtained by using only the intensity information of the continuous pixels.

The differential phase value obtained by using only the intensity information of the continuous pixels mentioned in the exemplary embodiments of the present invention and the present specification refers to a differential phase value obtained by using only intensity information of spatially continuous pixels. That is, this differential phase value is a differential phase value obtained by using only the intensity information of the spatially continuous pixels as the intensity information at the time of the phase retrieval.

The spatially continuous pixels refer to a pixel group where x or y coordinates are continuous integers like n, n−1, and n−2. For example, in a case where the differential phase values are obtained by using only one intensity distribution, the spatially continuous pixels refer to the differential phase values obtained by using only the intensity information of spatially continuous pixels in the one intensity distribution. On the other hand, in a case where the differential phase values are obtained by using a plurality of intensity distributions, the spatially continuous pixels refer to the differential phase values obtained by extracting only intensity information of the continuous pixels from each of the intensity distributions among the plurality of used intensity distributions and using the extracted pieces of intensity information.

The integration unit 220 receives the input of the weighted differential phase image to obtain the weighted differential phase image and integrates this weighted differential phase image to obtain the phase image. In this manner, the differential phase values having the low accuracy are lightly weighted, and then the integration is performed, so that it is possible to alleviate the influence on the phase image from these differential phase values.

FIG. 1B illustrates a phase image obtaining method performed by the calculation apparatus 170. The phase image obtaining method performed by the calculation apparatus 170 includes a differential phase image obtaining process S10, a weighting process S11, and an integration process S12. The differential phase image obtaining process S10 is performed by the differential phase image obtaining unit 250. The weighting process S11 is performed by the weighting unit 210, and the integration process S12 is performed by the integration unit 220.

It is noted that the calculation apparatus 170 may receive the input of the differential phase image instead of the input of the intensity distribution. In this case, the calculation apparatus is not provided with the differential phase image obtaining unit, and the differential phase image obtaining process is performed when the input of the differential phase image is received from an external part.

According to the fourth exemplary embodiment, at least a part of the differential phase values corresponding to the end parts of the intensity distribution in the differential phase image are not calculated. In other words, according to the fourth exemplary embodiment, the weighted differential phase image is directly obtained without the transition of the differential phase image of the entire intensity distribution, and this weighted differential phase image is integrated to obtain the phase image. FIG. 1C is a functional block diagram of a calculation apparatus according to the fourth exemplary embodiment. A calculation apparatus 230 according to the fourth exemplary embodiment is constituted by a differential phase image obtaining unit 240 and the integration unit 220. The differential phase image obtaining unit 240 obtains the differential phase image by using the intensity distribution. At this time, a difference from the differential phase image obtaining unit 250 according to the first to third exemplary embodiments resides in that the weighted differential phase image is obtained while the differential phase values in the end parts are not obtained.

The integration unit 220 is similar to the integration unit according to the first to third exemplary embodiments, and the phase image is obtained by integrating the differential phase image obtained by the differential phase image obtaining unit 240. A phase image obtaining method (not illustrated) which is performed by the calculation apparatus according to the fourth exemplary embodiment includes a differential phase image obtaining process and an integration process. The differential phase image obtaining process is performed by the differential phase image obtaining unit 240, and the integration process is performed by the integration unit 220.

According to the respective exemplary embodiments, descriptions will be given of a mode in which an X-ray Talbot-Lau interferometer is used as the differential interferometer, and a phase image is obtained by using an intensity distribution obtained by the X-ray Talbot-Lau interferometer, but other differential interferometers can also be used. Alternatively, an electromagnetic wave such as light may be used instead of the X-rays, or an electron beam can also be used.

### First Exemplary Embodiment

According to the present exemplary embodiment, descriptions will be given of a calculation apparatus that performs the weighting of the differential phase image by deleting the differential phase values in the lightly weighting area and obtains the phase image by integrating this weighted differential phase image.

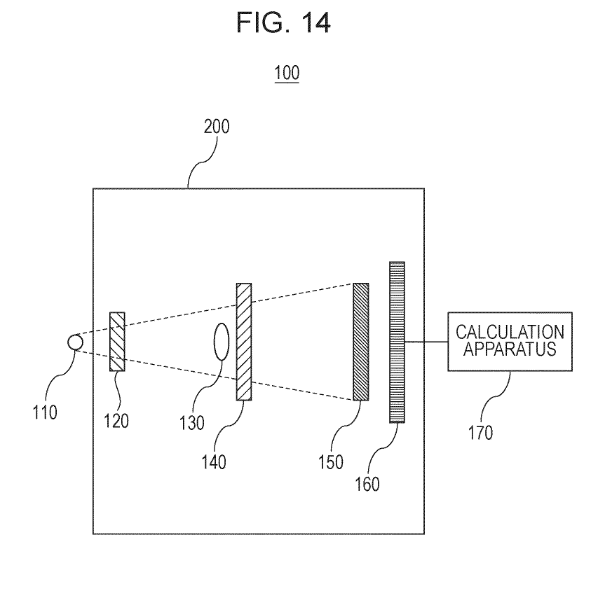

The calculation apparatus according to the present exemplary embodiment includes a differential phase image obtaining unit that performs a phase retrieval by using moire obtained by a Talbot-Lau interferometer illustrated in FIG. 14 as an intensity distribution to obtain the differential phase image. This interferometer uses X-rays as an electromagnetic wave. The Talbot-Lau interferometer is a type of a Talbot interferometer and uses Lau effects so that it is possible to form an intensity distribution having a higher contrast than that of an intensity distribution formed by the Talbot interferometer. Since a detail of the Talbot-Lau interferometer has been described, for example, in Proc. SPIE 6318, 63180S (2006), simple descriptions thereof will be given herein.

FIG. 14 is a schematic view of the Talbot-Lau interferometer 1 according to the present exemplary embodiment. The Talbot-Lau interferometer is provided with a source grating 120 that divides X-rays from an X-ray source 110, a diffractive grating 140 that forms an intensity distribution by using the X-rays from the source grating 120, a shielding grating 150 that shields a part of the X-rays from the diffractive grating 140, and a detector 160 that detects the X-rays from the shielding grating 150. A Talbot-Lau interferometer 200 can constitute a phase value obtaining system 100 together with the X-ray source 110 that irradiates the source grating 120 with the X-rays and the calculation apparatus 170 that obtains information of a subject on the basis of a detection result of the detector 160.

The source grating 120 includes an X-ray transmitting section and an X-ray shielding section and divides the X-rays from the X-ray source 110 into a beam shape. If a coherence of the X-rays emitted from the X-ray source to the diffractive grating is high to such an extent that an interference fringe can be formed by the diffractive grating, the source grating does not necessarily need to be provided. A subject 130 is irradiated with the X-rays divided by the source grating 120, and the X-rays that have transmitted through the subject 130 are diffracted by the diffractive grating.

The diffractive grating 140 is an optical element that forms the interference fringe called self-image by diffracting the X-rays. For example, a phase-type diffractive grating that periodically changes the phase of the X-rays or an amplitude-type diffractive grating that periodically changes the amplitude of the X-rays can be used as the diffractive grating 140. When the diffractive grating 140 diffracts the X-rays that have transmitted through the subject 130, the interference fringe of the X-rays is formed at a predetermined distance called Talbot distance.

The shielding grating 150 is arranged at a position away from the diffractive grating 140 by the Talbot distance such that the interference fringe is formed on the shielding grating 150. In the shielding grating 150, the X-ray shielding section and the X-ray transmitting section are periodically arranged. Since a period in which the X-ray shielding section and the X-ray transmitting section are arranged is slightly different from a period of the interference fringe formed on the shielding grating 150, the X-rays that have transmitted through the shielding grating 150 form moire. According to the present exemplary embodiment, this moire is used as the intensity distribution, and the differential phase image and the phase image are obtained. The detector 160 includes a plurality of pixels that detect an intensity of X-rays and obtains information of the moire by detecting the X-rays from the shielding grating 150. It is noted that rotation moire may be formed by setting the period of the shielding grating to be the same as the period of the interference fringe formed on the shielding grating to be rotated. Alternatively, the interference fringe may be directly detected by the detector instead of forming the moire by using the shielding grating. In that case, a detector having a spatial resolution with which the intensity distribution of the interference fringe can be obtained may be used.

The calculation apparatus 170 includes the differential phase image obtaining unit 250, the weighting unit 210, and the integration unit 220 and obtains the phase image by using the detection result of the detector 160.

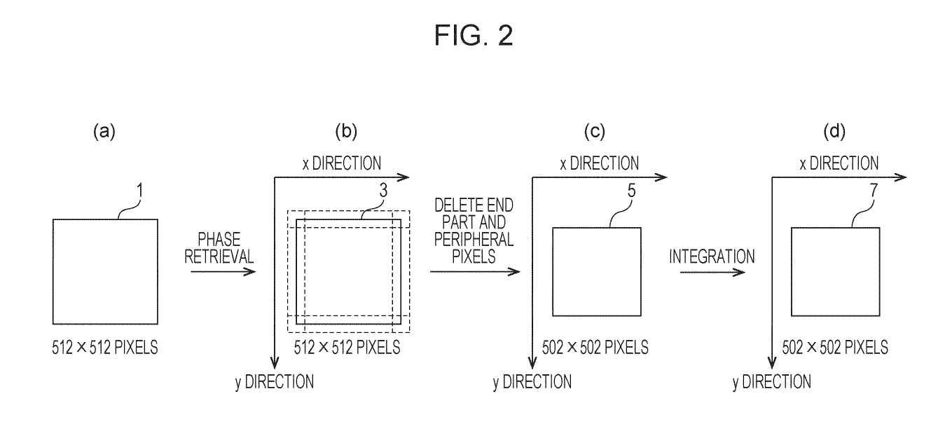

The phase image obtaining method performed by the calculation apparatus 170 will be described in detail by using FIG. 2. FIG. 2 is a schematic view illustrating an outline of the phase image obtaining method performed by the calculation apparatus. (a) of FIG. 2 illustrate the moire detected by the detector 160. Herein, descriptions will be given of a case where an area sensor corresponding to 512×512 pixels is used as the detector, and the calculation apparatus obtains an intensity distribution 1 corresponding to 512×512 pixels from the detector. The intensity distribution, the differential phase image, and the phase image are illustrated in white background herein. The differential phase image obtaining unit 250 performs the process S10 of obtaining a differential phase image 3 by employing a phase retrieval method such as a Fourier transform method of obtaining a differential phase value for one pixel by using intensity information of a plurality of pixels in one intensity distribution ((b) of FIG. 2). The weighting unit 210 deletes the differential phase values in the lightly weighting area from the obtained differential phase image to perform the weighting process S11. No particular limitation exists on the deleting method to be employed. For example, a rectangular filter smaller than the differential phase image may also be used. Alternatively, such a program may be created that coordinates of the differential phase image are specified, and the differential phase image within the specified range may be designated as the weighted differential phase image in the integration process (S12).

The lightly weighting area may be only the end parts or may also include pixels in the periphery thereof. This setting is preferably determined by taking into account the method of obtaining the differential phase image from the intensity distribution and the position in the differential phase image of the differential phase value. Depending on the method of obtaining the differential phase image from the intensity distribution, the differential phase values of the pixels in the periphery of the end parts may also be obtained by using the intensity information of the discontinuous pixels in some cases.

For example, the Fourier transform of the intensity distribution is performed, and an area where a peak of the carrier frequency is set as the center is cut out from the obtained frequency spectrum by using a filter function. Then, the cut-out area is moved to an origin of a blank frequency spectrum space, and the inverse Fourier transform is performed to obtain the differential phase image. In this case, the number of pixels obtained by using the intensity information of the discontinuous pixels is determined depending on a size of the filter function used for cutting out the area where the peak of the carrier frequency is set as the center from the frequency spectrum. It is however noted that, in the exemplary embodiments of the present invention and the present specification, the size of the filter function refers to a size on the real space, and in a case where the filter function is used on the frequency spectrum space, the size of the filter function refers to a size when the filter is converted into the real space.

In a case where an area is cut out while a peak of the carrier frequency derived from a period in an x direction (horizontal axis direction) is set as the center, when the filter function has a size of three pixels, the differential phase values for one column from the end part (that is, only the end part) based on (3−1)/2=1 are obtained by using the intensity information of the discontinuous pixels. Similarly, when the filter function has a size of six pixels, the differential phase values for three columns from the end part based on (6−1)/2=2.5 are obtained by the intensity information of the discontinuous pixels. It is however noted that the size of the filter function refers to a range in which a highest value of the filter becomes 1% or higher. For example, in the case of Gaussian function, while a variance is set as σ², 6σ can be regarded as the size of the filter function. In general, the differential phase image is obtained by the above-described method, and the size of the filter function is three pixels or larger. On the other hand, as described in Japanese Patent Laid-Open No. 2011-153969, when the area where the peak of the carrier frequency is set as the center is cut out after a zeroth order peak is cancelled by using two intensity distributions, the size of the filter function can be set as two pixels. In this case, the differential phase values for one column from the end part are obtained by using the intensity information of the discontinuous pixels. In addition, as described in “Windowed Fourier transform method for demodulation of carrier fringes,” Opt. Eng. 43(7) 1472-1473 (July 2004), the Fourier transform of the periodic intensity distribution (which may be referred to as periodic pattern in some cases) may be performed for every plural areas. In the case of this method, the number of pixels of the differential phase values obtained by using the intensity information of the discontinuous pixels is determined on the basis of the size of the filter function used for cutting out the area while the peak of the carrier frequency is set as the center from a Fourier spectrum for each area obtained by performing the Fourier transform for each area.

In addition, as described in Japanese Patent Laid-Open No. 2013-050441, intensity information of a certain pixel and its peripheral pixel is taken from each of the plurality of intensity distributions to obtain one differential phase value. In this case, the number of pixels obtained by using the intensity information of the discontinuous pixels is determined in accordance with the number of pieces of intensity information taken out from one intensity distribution. It is however noted that, in a case where the number of pixels varies for each intensity distribution, the number of pixels obtained by using the intensity information of the discontinuous pixels is determined in accordance with a highest value of the number of pixels to be taken out. For example, in a case where intensity information for two pixels is taken out from a first intensity distribution and intensity information for one pixel is taken out from a second intensity distribution to obtain one differential phase value, the differential phase values for one column from the end part are obtained by using the intensity information of the discontinuous pixels.

However, all the differential phase values obtained by using the intensity information of the discontinuous pixels do not necessarily need to be deleted. As the number of differential phase values to be deleted is increased, the number of pixels of the phase image to be obtained is decreased. Thus, it is possible to determine the number of pixels to be deleted by taking into account to what extent the influence caused by the differential phase values having the low accuracy is acceptable and the number of pixels of the phase image desired to be obtained. Even in a case where the differential phase values in a plurality of columns or rows are obtained by using the intensity information of the discontinuous pixels, with regard to the differential phase value, the accuracy of the differential phase value to be obtained is further decreased as the pixel is closer to the end part in principle. Thus, deletion of the differential phase values of only the end parts is more advantageous than deletion of the differential phase values of the other pixels in terms of the accuracy increase in the phase image with respect to a disadvantage of the decrease in the number of pixels of the phase image. Thus, at least one pixel in the end parts is set as the lightly weighting area. The lightly weighting area may be set in units of pixel column or pixel row or may be set in units of pixel.

The number of pixels of the phase image desired to be obtained is preferably determined by taking into account not only a relationship between a size of an image pickup range and a size of an observation area of the subject but also a relationship between the observation area of the subject and the position in the image pickup range. For example, even when the observation area of the subject is small with respect to the image pickup range, if the relevant observation area exits in the area of the three pixels from the end part, the lightly weighting area is not preferably set as a pixel column and a pixel row within the three pixels from the end part because information of the observation area is lost. In addition, for example, in a case where the observation area is biased towards the right side in the image pickup range, the number of rows of the pixels to be deleted from the right end of the differential phase image may be set to be lower than the number of rows of the pixels to be deleted from the left end. Moreover, the numbers of columns and rows of the pixels to be deleted may be arbitrarily determined, and five rows on the left and right and the three columns on the top and bottom may be set as the deletion targets, for example. That is, the numbers of rows and columns of the pixels to be deleted may be arbitrarily determined. The numbers of rows may be different from each other, and the numbers of columns may be different from each other.

In a case where the differential phase image in one direction (the differential phase image obtained by differentiating the phase image in the x direction or a y direction) is integrated, it may suffice when only the row or column perpendicular to the integrating direction is deleted. It is noted that, in the exemplary embodiments of the present invention and the present specification, the differential phase image obtained by differentiating the phase image in the x direction will be referred to as differential phase image in the x direction, and the differential phase image obtained by differentiating the phase image in the y direction will be referred to as differential phase image in the y direction. For example, in a case where a horizontal direction is set as the x direction, and the differential phase image in the x direction dΦ(x, y)/dx is used, the integration unit integrates the weighted differential phase image in the x direction. In this case, since the integration is not performed in the y direction corresponding to a vertical direction, the influence from the decrease in the accuracy of the top and bottom end parts is not also spread in the phase image. Thus, the lightly weighting area is preferably set as an area having at least one pixel in the left and right pixel columns arranged in the y direction perpendicular to the x direction in the end parts of the differential phase image. On the other hand, in a case where one differential phase image is obtained by integrating the differential phase images in two directions (the differential phase image in the x direction and the differential phase image in the y direction), the differential phase image in the x direction is integrated in the x direction, and the differential phase image in the y direction is integrated in the y direction. Thus, the lightly weighting area is preferably set as an area having at least one pixel in the pixel columns on the left end and the right end arranged in the y direction and at least one pixel in the pixel rows on the top end and the bottom end arranged in the x direction in the end parts of the differential phase image.

In addition, the lightly weighting area may be determined by taking a start position of the integration into account.

For example, when the integration is performed from the row on the left end towards the right direction in a case where the differential phase value is integrated, the influence on the phase value from the row on the left end corresponding to the start position of the integration is larger than that from the row on the right end corresponding to a goal position of the integration. Thus, in a case where the end part of the weighted differential phase image is set as the start position of the integration, the row or the column corresponding to the start position is preferably included in the lightly weighting area.

In a case where the setting unit of the lightly weighting area is set as in units of pixel, for example, the pixels are divided into the pixel where the differential phase value abruptly changes and the pixel where the differential phase value does not abruptly change by comparing with the peripheral pixel in the end part, and the pixel where the differential phase value abruptly changes may be set as the lightly weighting area. In this case, the pixel where a difference of the differential phase value from the adjacent pixel is higher than or equal to an arbitrary value may be set as the lightly weighting area, and the pixel where a difference from an average value of the differential phase values of the peripheral pixel is higher than or equal to an arbitrary value may also be set as the lightly weighting area.

Herein, a case where the pixel rows and the pixel columns from five pixels each from the end parts are set as the lightly weighting area will be described as a specific example. The weighting unit of the calculation apparatus obtains a weighted differential phase image 5 having 502×502 pixels ((c) of FIG. 2) by deleting the differential phase values in the end parts. Subsequently, the integration unit can obtain a phase image 7 having 502×502 pixels by integrating the weighted differential phase image 5 ((d) of FIG. 2). No particular limitation exists on the integration method for the weighted differential phase image. For example, integration towards the horizontal axis direction (x axis direction) may be performed by simply performing addition from the right end or the left end, or integration may be performed by differentiating the differential phase image again and solving Poisson's equation as described in Japanese Patent Laid-Open No. 2013-102951. Alternatively, integration described in “Noniterative boundary-artifact-free wavefront reconstruction from its derivatives”, Applied Optics, Vol. 51, No. 23, 5698-5704 (2012) may be performed.

The obtained phase image may be displayed by an image display apparatus (not illustrated) which is connected to the calculation apparatus. Various displays, printers, or the like can be used as the image display apparatus. The phase image may be displayed as a list of the phase values where positional information is displayed instead of being displayed as the image, or a calculation is further added on the phase image, and the result may be displayed. In a case where both the differential phase image and the phase image are displayed, since the number of pixels is higher in the differential phase image before the weighting, the differential phase image before the weighting may be displayed as the differential phase image.

The calculation apparatus 170 may be constituted by a plurality of calculation apparatuses. For example, three calculation apparatuses in total including the calculation apparatus that performs up to the obtainment of the differential phase image, the calculation apparatus that performs the weighting of the differential phase image, and the calculation apparatus that integrates the weighted differential phase image to obtain the phase image may function as the calculation apparatus 170. In this manner, when the calculation apparatus 170 functions as the plurality of calculation apparatuses, if each of the calculation apparatuses can transmit and receive the obtained data, the calculation apparatuses do not need to be arranged to be physically close to each other.

### Second Exemplary Embodiment

According to the present exemplary embodiment, descriptions will be given of a calculation apparatus that performs weighting of the differential phase image by replacing the differential phase value in the lightly weighting area by another value. Since the calculation apparatus according to the present exemplary embodiment is similar to the first exemplary embodiment, descriptions thereof will be omitted except for a weighting method for the differential phase image by the weighting unit.

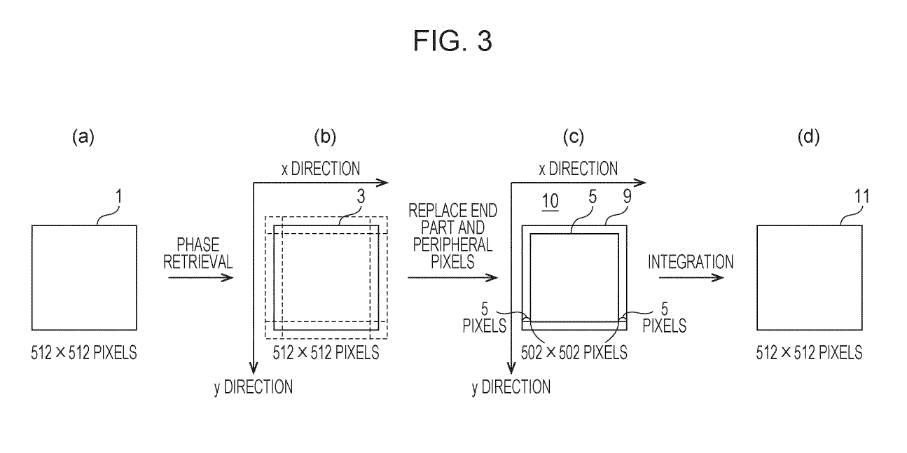

FIG. 3 is a schematic view illustrating an outline of the phase image obtaining method by the calculation apparatus. Similarly as in the first exemplary embodiment, the differential phase image obtaining unit obtains the differential phase image 3 ((b) of FIG. 3, 512×512 pixels) by using the intensity distribution 1 ((a) of FIG. 3, 512×512 pixels).

The weighting unit replaces the differential phase value in the lightly weighting area among the obtained differential phase images by another value to obtain the weighted differential phase image. Although the replacing value is preferably a value close to 0, it is possible to attain the effect of the present exemplary embodiment as long as the value is closer to 0 (in other words, the absolute value is lower) than the differential phase value before the replacement. For example, an average value of the differential phase values of the entire differential phase image may be obtained from the differential phase image before the weighting, and the differential phase value in the lightly weighting area may be replaced by the average value. This is because it is estimated that the average value of the differential phase values is closer to 0 than the value before the replacement in the lightly weighting area. In this manner, in a case where the value is replaced by a value other than 0, when viewed locally, an area where the absolute value of the differential phase value is increased by the replacement may exist in some cases. However, if the average value of the differential phase values after the replacement in the entire lightly weighting area is lower than the average value of the differential phase values before the replacement, it is possible to attain the effect of the present exemplary embodiment. In other words, the weighting unit according to the present exemplary embodiment sets the average value of the absolute values of the differential phase values in the lightly weighting area in the weighted differential phase image to be lower than the average value of the absolute values of the differential phase values in the lightly weighting area in the differential phase image input to the weighting unit. The weighting is preferably performed such that the average value of the absolute values of the differential phase values in the lightly weighting area in the weighted differential phase image is set to be ½ or lower of the average value of the absolute values of the differential phase values in the lightly weighting area in the differential phase image input to the weighting unit. The weighting is further preferably performed such that the average value of the absolute values of the differential phase values in the lightly weighting area in the weighted differential phase image is set to be 1/10 of the average value of the absolute values of the differential phase values in the lightly weighting area in the differential phase image input to the weighting unit or lower.

When the replacement of the differential phase value is performed, the replaced range does not have accurate information of the subject. Thus, the lightly weighting area can be determined similarly as in the lightly weighting area according to the first exemplary embodiment. The setting unit for the lightly weighting area may be in units of column, in units of row, or in units of pixel similarly as in the first exemplary embodiment. In a case where the lightly weighting area is set in units of pixel, the lightly weighting area can be determined similarly as in the first exemplary embodiment. In addition, the lightly weighting area may not be horizontally symmetric or vertically symmetric similarly as in the first exemplary embodiment. In a case where both the differential phase image and the phase image are displayed, the differential phase image before the weighting may be displayed as the differential phase image.

Herein, descriptions will be given of a case where the pixel rows and the pixel columns for five pixels each from the end parts are set as the lightly weighting area, and the differential phase values in the lightly weighting area are replaced by 0 as an example. The weighting unit replaces the differential phase values in the rows or columns for top, bottom, right, and left five pixels each including the end parts by 0. Accordingly, a weighted differential phase image 10 ((c) of FIG. 3) is obtained. The weighted differential phase image 10 can be regarded as a differential phase image where the differential phase image 5 is arranged in the area 9 such that a center of an area 9 of 512×512 pixels where the differential phase value is 0 is matched with a center of the differential phase image 5 having 502×502 pixels. Subsequently, while the weighted differential phase image is integrated, a phase image 11 having 512×512 pixel can be obtained ((d) of FIG. 3).

### Third Exemplary Embodiment

According to the present exemplary embodiment, descriptions will be given of a calculation apparatus that performs weighting of the differential phase image by an application of such a filter that the absolute value of the differential phase value in the lightly weighting area is decreased. Since the calculation apparatus according to the present exemplary embodiment is similar to the first exemplary embodiment, descriptions thereof will be omitted except for a weighting method for the differential phase image by the weighting unit.

The differential phase image obtaining unit obtains the differential phase image by using the intensity distribution similarly as in the first exemplary embodiment.

The weighting unit applies the filter to the obtained differential phase image such that the differential phase value in the lightly weighting area with respect to the differential phase value in the central part is decreased. In other words, the average value of the differential phase values in the lightly weighting area/the differential phase value in the central part (it is however noted that, when a plurality of differential phase values exist, an average value thereof is used) is decreased. No particular limitation exists on a shape of the filter as long as the differential phase value in the lightly weighting area with respect to the differential phase value in the central part becomes smaller than that before the application of the filter. For example, it is possible to use a filter with which the absolute values of the differential phase values in the lightly weighting area are uniformly decreased (for example, the absolute values of the differential phase values in the lightly weighting area are multiplied by a predetermined value lower than or equal to 1). In a case where the lightly weighting area includes the peripheral pixel of the end part, a filter with which the absolute value is decreased as the pixel is closer to the end part in the lightly weighting area is preferably used. In addition, since it is sufficient if the differential phase value in the lightly weighting area with respect to the differential phase value in the central part is decreased, for example, a filter with which the differential phase value in the lightly weighting area remains as it is, and the absolute value of the differential phase value in the central part is increased. When a value of the filter applied to the differential phase value in the central part (it is however noted that an average value is set as the value in a case where a plurality of central parts exist) is set as 1, an average value of the values of the filters applied to the differential phase values in the lightly weighting area is preferably lower than or equal to 0.5. Furthermore, when an average value of the values of the filters applied to the differential phase values obtained by using only the intensity information of spatially continuous pixels is set as 1, the average value of the values of the filters applied to the differential phase values in the lightly weighting area is preferably lower than or equal to 0.5. It is noted that the differential phase value of the pixel that is neither the central part nor the lightly weighting area is preferably multiplied by the same value as the value of the filter applied to the differential phase value in the central part. In addition, the filter may be applied to the entire differential phase image or may be applied to only the lightly weighting area.

The lightly weighting area can be determined similarly as in the first exemplary embodiment. The setting of the lightly weighting area may be in units of column, in units of row, or in units of pixel similarly as in the first exemplary embodiment. In a case where the lightly weighting area is set in units of pixel too, the lightly weighting area can be determined similarly as in the first exemplary embodiment. In addition, the lightly weighting area may not be horizontally symmetric or vertically symmetric similarly as in the first exemplary embodiment. In a case where both the differential phase image and the phase image are displayed, the differential phase image before the weighting may be displayed as the differential phase image.

In a case where the pixel rows and the pixel columns for five pixels each from the end parts are set as the lightly weighting area, the present exemplary embodiment is different from the second exemplary embodiment (FIG. 3) in that the differential phase value of the area 9 in (c) of FIG. 3 is not 0 but is a differential phase value having an absolute value decreased by the filter. However, the phase image having 512×512 pixels is similarly obtained by using the differential phase image having 512×512 pixels as in the second exemplary embodiment.

### Fourth Exemplary Embodiment

According to the present exemplary embodiment, descriptions will be given of a calculation apparatus that does not obtain the differential phase value in the area having at least one pixel in the end part when the differential phase image is obtained.

The calculation apparatus according to the present exemplary embodiment includes the differential phase image obtaining unit 240 similarly as in the calculation apparatus according to the first exemplary embodiment. It is however noted that the differential phase image obtaining unit according to the present exemplary embodiment is different from the differential phase image obtaining unit according to the first exemplary embodiment in that the differential phase value of the area having at least one pixel in the end parts is not obtained when the differential phase image is obtained. In other words, the weighted differential phase image obtained in the first exemplary embodiment ((c) of FIG. 2) is directly obtained from the intensity distribution ((a) of FIG. 2) (without the transition of the differential phase image in the entire image pickup range ((b) of FIG. 2)). That is, the differential phase image obtaining unit 240 according to the present exemplary embodiment has both functions of the differential phase image obtaining unit 250 according to the first exemplary embodiment and the weighting unit 210. As a method of obtaining the differential phase image, a method of obtaining the differential phase image for each area of the periodic pattern can be employed such as a method disclosed in “Windowed Fourier transform method for demodulation of carrier fringes,” Opt. Eng. 43(7) 1472-1473 (July 2004) or a method disclosed in Japanese Patent Laid-Open No. 2013-050441.

A case where the pixel rows and the pixel columns for five pixels each from the end parts are set as the area where the differential phase values are not obtained, the differential phase values in this area are not obtained will be described as an example. The differential phase image obtaining unit 240 of the calculation apparatus receives the intensity distribution (same as (a) of FIG. 2) having 512×512 pixels from the detector, and the differential phase image is obtained by performing the phase retrieval. At this time, since the differential phase values in the pixel rows and the pixel columns for five pixels each from the end parts are not obtained, the obtained differential phase image has 502×502 pixels, which are equal to those of the weighted differential phase image obtained in the first exemplary embodiment ((c) of FIG. 2). Thus, in the exemplary embodiments of the present invention and the present specification, the configuration in which the differential phase values corresponding to the end parts of the intensity distribution which are obtained from the detector are not obtained, and the differential phase image having the number of pixels fewer than the number of pixels of the intensity distribution is obtained in the above-described manner is also referred to as weighting of the differential phase values in the end parts more lightly than the differential phase value in the central part.

Similarly as in the integration unit according to the first exemplary embodiment, the integration unit 220 integrates the weighted differential phase image to obtain the phase image. According to the present exemplary embodiment, it is possible to obtain the phase image similar to that of the first exemplary embodiment. In a case where the same phase retrieval method is used, the time to obtain the weighted differential phase image according to the present exemplary embodiment is shorter than that according to the first to third exemplary embodiments. However, the number of pixels of the weighted differential phase image obtained according to the present exemplary embodiment is fewer than the number of pixels of the differential phase image obtained according to the first to third exemplary embodiments. Thus, for example, in a case where information of the differential phase image itself is needed, and the differential phase values in the area corresponding to the area where the differential phase values are not obtained according to the present exemplary embodiment are desired to be obtained even though the accuracy is low such as a case where the differential phase image is desired to be observed, the first to third exemplary embodiments are preferably carried out.

According to the present exemplary embodiment too, the area where the differential phase values are not obtained can be determined in a similar manner for determining the lightly weighting area according to the first exemplary embodiment. In addition, similarly as in the first exemplary embodiment, the setting of the area where the differential phase values are not obtained may be in unit of pixel row, in unit of pixel column, or in unit of pixel. In a case where the setting is performed in unit of pixel, for example, the pixel where the differential phase value is not obtained can be determined in accordance with a position of the subject in the intensity distribution. Moreover, similarly as in the first exemplary embodiment, the area where the differential phase values are not obtained may not be horizontally symmetric or vertically symmetric.

It is noted that the calculation apparatus may perform a plurality of phase image obtaining methods among the first to fourth exemplary embodiments. In that case, a configuration may be adopted in which the phase image obtaining method that can be performed by the calculation apparatus can be appropriately switched by a user, or the calculation apparatus may appropriately select the phase image obtaining method in accordance with the differential phase image obtaining method or the differential phase image. For example, in a case where the differential phase value is obtained by the Fourier transform method or a case where a window function used when a spectrum is cut out from Fourier space is large, the differential phase values obtained from the intensity distributions of the discontinuous pixels are localized in the end parts, and therefore the first, second, or fourth exemplary embodiment is selected. On the other hand, in a case where the window function is small, the differential phase values obtained from the intensity distributions of the discontinuous pixels spread to several pixels from the end part, and the reliability is increased as a distance from the end part is increased. Therefore, the third exemplary embodiment is preferably selected to change the weighting also within the lightly weighting area.

In addition, a plurality of phase image obtaining methods may be performed, and a plurality of phase images where the phase image obtaining methods are different from each other may be obtained. In this case, a plurality of phase images may be displayed.

### EXAMPLES

Hereinafter, examples and comparison examples will be described.

### Comparison Example 1

According to the present comparison example, descriptions will be given of an example in which a phase image is obtained by an integration method described in “Noniterative boundary-artifact-free wavefront reconstruction from its derivatives”, Applied Optics, Vol. 51, No. 23, 5698-5704 (2012) by using a simulation.

An intensity distribution gᵣ(x, y) without an influence from a subject and an intensity distribution gₛ(x, y) having the influence from the subject set in the simulation are represented by the following expressions.

gᵣ(x,y)=a(x,y)×(1+b(x,y)cos(2πf₀x))×(1+b(x,y)cos(2πf₀y))

gₛ(x,y)=a(x,y)×(1+b(x,y)cos(2π(f₀x+pₓ(x,y))))×(1+b(x,y)cos(2π(f₀y+p_{y}(x,y))))

f₀=1/p_{d}/pₘ

pₓ(x,y)=α×(dΦ(x,y)/dx)

p_{y}(x,y)=α×(dΦ(x,y)/dy)

Where x and y denote coordinates representing a position in units of pixel, and p_{d} denotes a pixel size and is set as 10 μm according to the present comparison example. pₘ denotes a period of a periodic pattern in units of pixel and is set as 8 pixels according to the present comparison example, and α denotes a constant and is set as 72500 according to the present comparison example. A calculation area is set as 500×500 pixels, that is, 5 mm×5 mm. a(x, y) and b(x, y) are set as fixed values, and a phase image Φ(x, y) is set to have a spherical subject with a diameter of 2.5 mm positioned at an end of the calculation area.

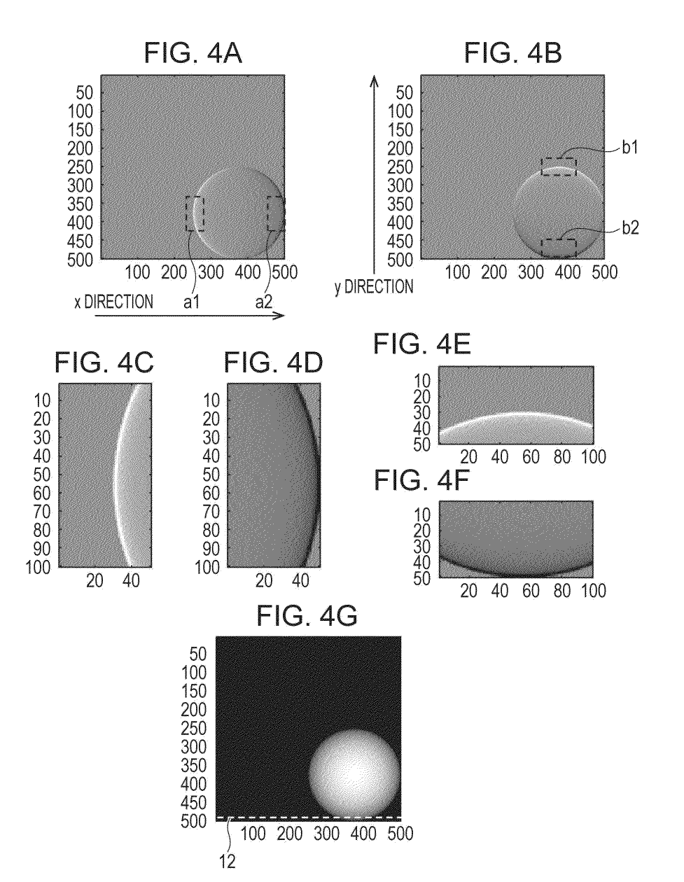

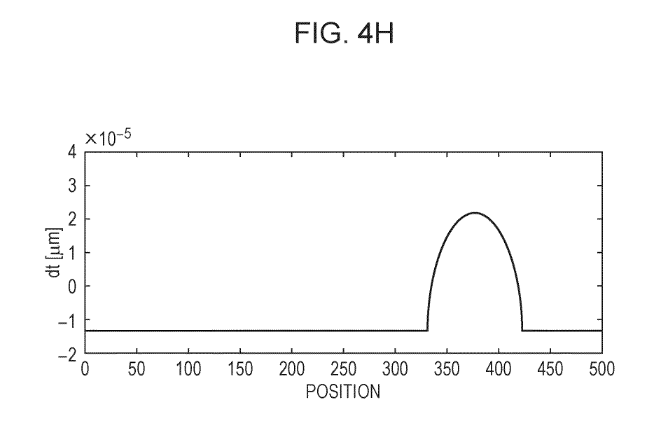

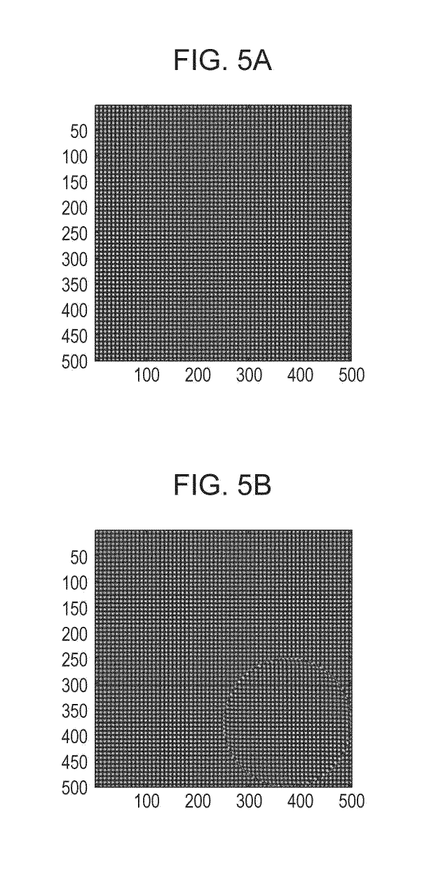

The spherical phase image Φ(x, y) used in the simulation is illustrated in FIG. 4G, and a line profile of a dotted line 12 in FIG. 4G is illustrated in FIG. 4H. dΦ(x, y)/dx is illustrated in FIG. 4A, an enlarged view in a frame a1 of the dotted line in FIG. 4A is illustrated in FIG. 4C, and an enlarged view in a frame a2 of the dotted line in FIG. 4A is illustrated in FIG. 4D. dΦ(x, y)/dy is illustrated in FIG. 4B, an enlarged view in a frame b1 of the dotted line in FIG. 4B is illustrated in FIG. 4E, and an enlarged view in a frame b2 of the dotted line is illustrated in FIG. 4F. FIG. 5A illustrates gᵣ(x, y), and FIG. 5B illustrates gₛ(x, y). That is, FIGS. 4A to 4H and FIGS. 5A and 5B illustrate input values according to the present comparison example.

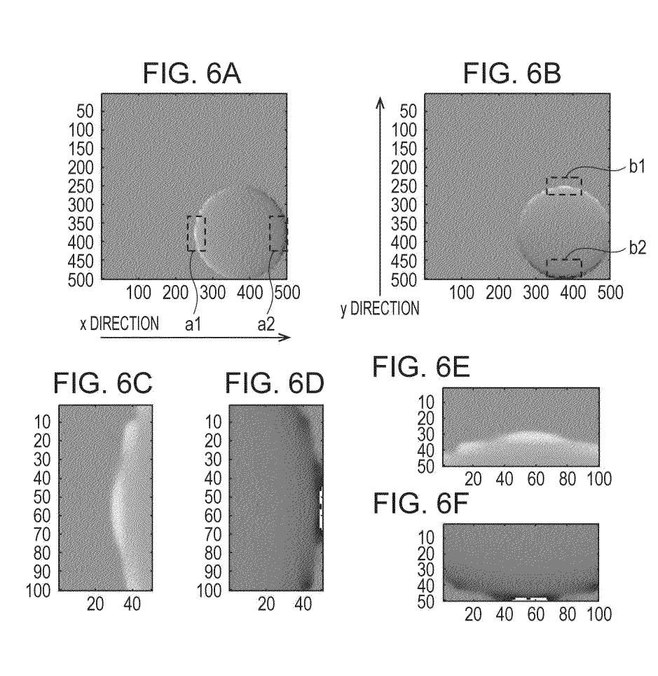

The differential phase image obtained by the Fourier transform method is obtained by using the periodic pattern represented by FIGS. 5A and 5B. That is, the Fourier transform of FIG. 5A is performed, and a spectrum of the carrier frequency in the x direction on the Fourier space is cut out by using the filter function. The filter function is set as a Fourier spectrum of the Gaussian function set in the real space, and a square root (σ) of the variance of the Gaussian function is set as 2.5 pixels. The cutout spectrum is moved to an origin of another Fourier space, and the inverse Fourier transform of this spectrum is performed to obtain dΦᵣ(x, y)/dx. Similarly in FIG. 5B too, processes from the Fourier transform to the inverse Fourier transform are performed to obtain dΦₛ(x, y)/dx. The differential phase image in the x direction dΦ(x, y)/dx is obtained by taking out a difference between dΦₛ(x, y)/dx and dΦᵣ(x, y)/dx. Similarly, a spectrum of the carrier frequency in the y direction on the Fourier space is cut out, and a difference between dΦₛ(x, y)/dy and dΦᵣ(x, y)/dy is taken out to obtain the differential phase image in the y direction dΦ(x, y)/dy. dΦ(x, y)/dx and dΦ(x, y)/dy are respectively illustrated in FIGS. 6A and 6B. Similarly as in FIGS. 4A to 4H, FIGS. 6C and 6D are respectively enlarged views in frames a1 and a2 of a dotted line in FIG. 6A. FIGS. 6E and 6F are respectively enlarged views in frames b1 and b2 of a dotted line in FIG. 6B. Each of the differential phase values of the differential phase images illustrated in FIGS. 6A and 6B is obtained by using the intensity information for 6σ=15 pixels, and the differential phase values in (15−1)/2=7 rows and columns from the end parts are obtained by using the intensity information of the discontinuous pixels.

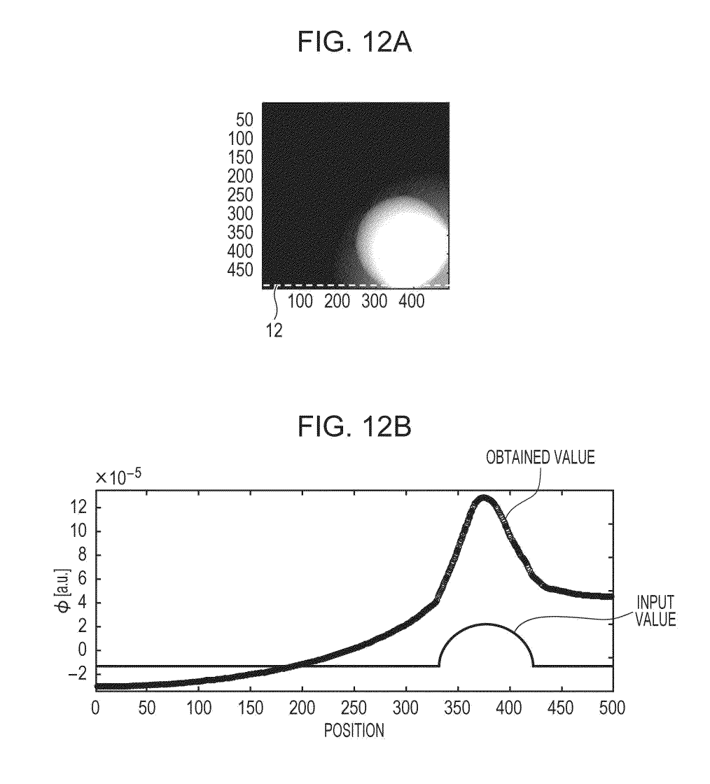

Φ(x, y) is obtained by using the integral method described in “Noniterative boundary-artifact-free wavefront reconstruction from its derivatives”, Applied Optics, Vol. 51, No. 23, 5698-5704 (2012) by using dΦ(x, y)/dx and dΦ(x, y)/dy. Φ(x, y) is illustrated in FIG. 12A, and a line profile of the dotted line 12 in FIG. 12A is illustrated in FIG. 12B.

When the differential phase values dΦ(x, y)/dx in a left end part of the sphere of the subject illustrated in FIG. 4C and FIG. 6C are compared with each other, it can be understood that the differential phase image obtained according to the present comparison example is blurred with respect to the image (FIG. 4C) based on the input values. On the other hand, when the differential phase values in a right end part of the sphere illustrated in FIG. 4D and FIG. 6D are compared with each other, it can be understood that the differential phase image obtained according to the present comparison example is not only blurred with respect to the image (FIG. 4D) based on the input values but also has largely varied values. This is because the right end part of the sphere is in the end part of the periodic pattern, and the differential phase values are obtained by using the pixels in the left end part of the periodic pattern, so that it can be understood that the accuracy of the differential phase image in the right end part of the sphere is decreased. In the case of dΦ(x, y)/dy illustrated in FIGS. 4E and 4F and FIGS. 6E and 6F too similarly as in the case of dΦ(x, y)/dx, it can be understood that the differential phase image obtained according to the present comparison example (FIG. 6F) in a bottom end part of the sphere is largely different from the image (FIG. 4F) based on the input values. In addition, when FIGS. 12A and 12B are observed, the input values and the obtained phase values are deviated from each other not only the end parts and the periphery thereof but also over the entire line of the dotted line 12, and it can be understood that the phase values in not only the end parts and the periphery thereof but also the entire phase image are deviated from the input values.

### Comparison Example 2

According to the present comparison example, a periodic pattern is applied with such a filter that the intensity is set to smoothly approach 0 towards the end parts of the periodic pattern, and a simulation result analyzed by the Fourier transform method will be described.

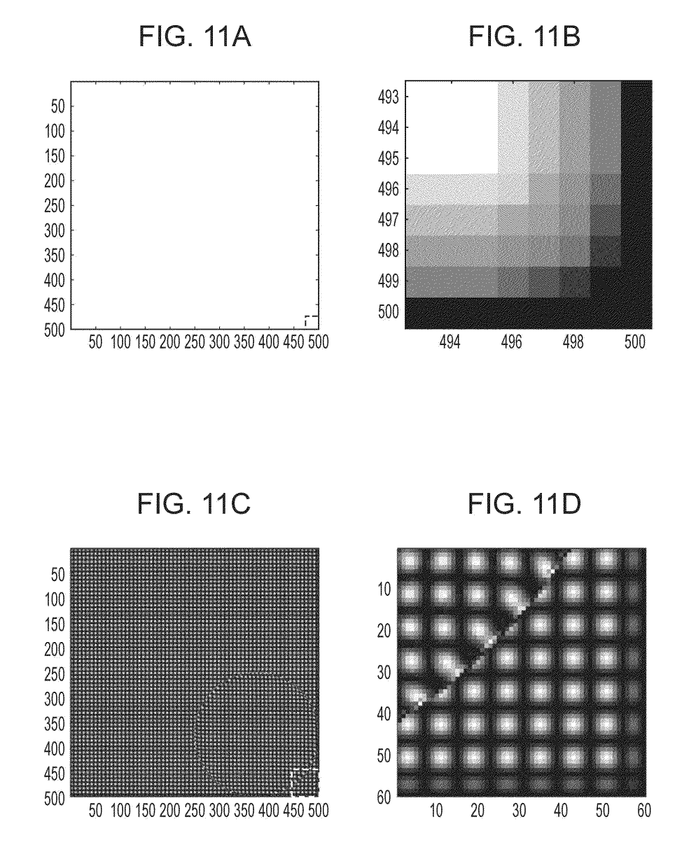

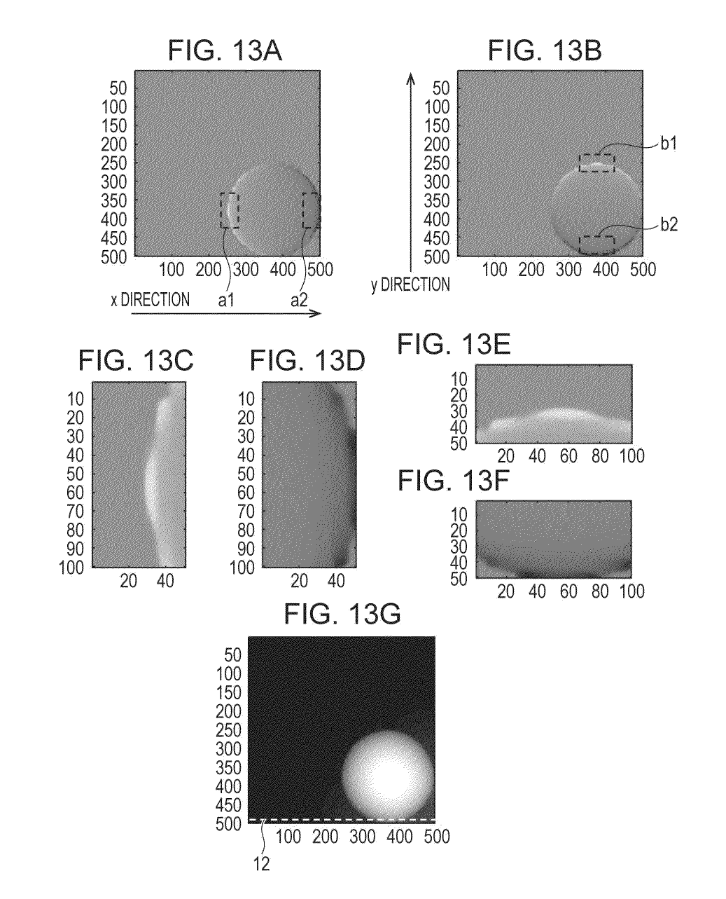

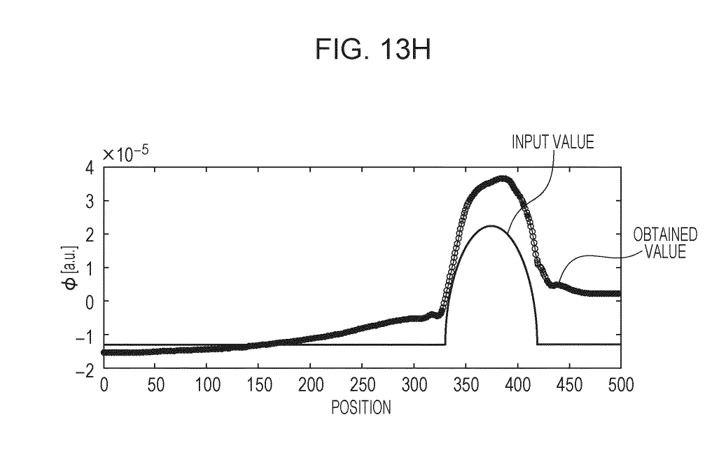

FIG. 11A illustrates the filter used according to the present comparison example and an enlarged view thereof. An enlarged view of a range surrounded by a dotted line in FIG. 11A is illustrated in FIG. 11B. The filter illustrated in FIGS. 11A and 11B has a sine curve that becomes 0 in the end part and becomes 1 at the sixth pixel including the end part. That is, five pixels including the end part are weighted. FIG. 11C illustrates a periodic pattern obtained by applying the filter illustrated in FIG. 11A to the periodic pattern gₛ(x, y) having the subject. An enlarged view of a range surrounded by a dotted line in FIG. 11C is illustrated in FIG. 11D. With regard to the periodic pattern applied with the filter, the intensity is set to smoothly becomes zero in the end parts (the right end and the bottom end in FIGS. 11A to 11D). The differential phase image is obtained by using the periodic pattern illustrated in FIG. 11C similarly as in Comparison Example 1. The obtained dΦ(x, y)/dx and dΦ(x, y)/dy are respectively illustrated in FIGS. 13A and 13B. Similarly as in FIGS. 6A to 6F, FIGS. 13C and 13D are respectively enlarged views in frames a1 and a2 of a dotted line in FIG. 13A. FIGS. 13E and 13F are respectively enlarged views in frames b1 and b2 of a dotted line in FIG. 13B. Φ(x, y) is obtained by using dΦ(x, y)/dx and dΦ(x, y)/dy obtained according to the present comparison example by employing the same method as Comparison Example 1. Φ(x, y) is illustrated in FIG. 13G, and a line profile of the dotted line 12 in FIG. 13G is illustrated in FIG. 13H. In FIG. 13H, a solid line corresponds to the input values (same as FIG. 4H), and a bold line corresponds to the line profile (referred to as obtained values) of Φ(x, y) obtained according to the present comparison example. When FIGS. 12A and 12B are compared with FIGS. 13D and 13F, it can be understood that the deviations from the input values of the differential phase values are alleviated with respect to Comparison Example 1 by applying the filter to the periodic pattern, and the effects attained by applying the filter to the periodic pattern can be confirmed.

### Example 1

According to Example 1, a more specific example of the first exemplary embodiment will be described by using a simulation result. According to the present example, descriptions will be given of an example in which the differential phase values in the lightly weighting area in the differential phase image are deleted.

According to the present example, in the differential phase image illustrated in FIGS. 6A and 6B, five rows or five columns each on the top, bottom, left, and right are set as the lightly weighting area, and the weighted differential phase image is obtained by deleting the differential phase values in this area. A part of the differential phase values obtained by using the intensity information of the discontinuous pixels remains without being weighted more lightly than the differential phase value in the central part, and with regard to the remaining differential phase values, 13 or more pixels are continuous among 15 pixels that use the intensity information. Thus, it is conceivable that the influence imparted on the accuracy of the differential phase values is small.

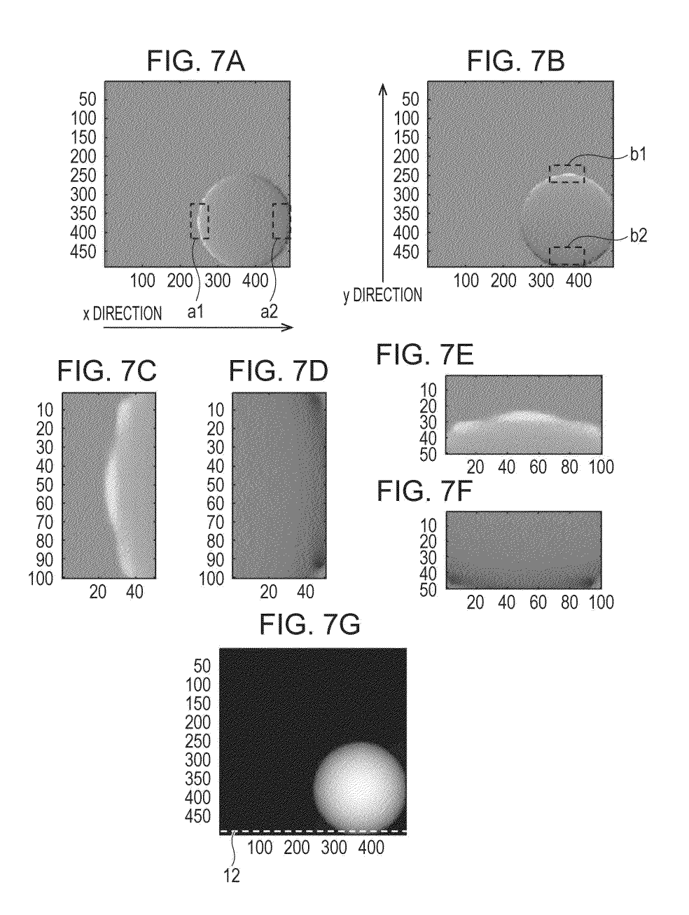

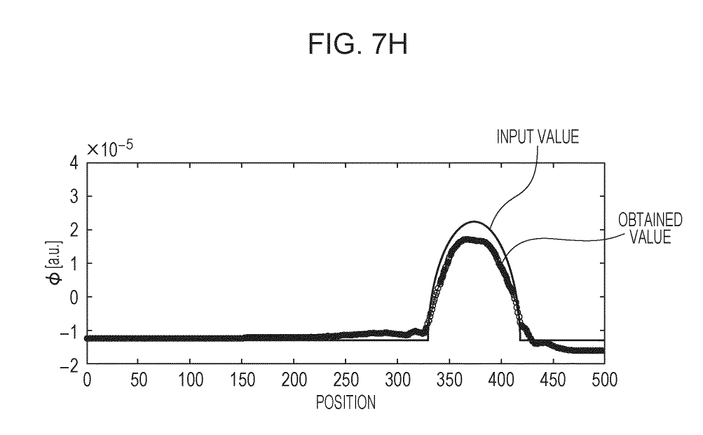

The top, bottom, left, and right part of the differential phase image having 500×500 pixels illustrated in FIGS. 6A and 6B are deleted to obtain a differential phase image having 490×490 pixels. The weighted differential phase image obtained according to the present example is illustrated in FIGS. 7A and 7B. Similarly as in FIGS. 6A to 6F, FIGS. 7C and 7D are respectively enlarged views in frames a1 and a2 of a dotted line in FIG. 7A. In addition, FIGS. 7E and 7F are respectively enlarged views in frames b1 and b2 of a dotted line in FIG. 7B. The phase image Φ(x, y) is obtained by using the weighted differential phase image obtained according to the present example by employing the same method as Comparison Examples 1 and 2. FIG. 7G illustrates the phase image, and a line profile of the dotted line 12 in FIG. 7G is illustrated in FIG. 7H. In FIG. 7H too, a solid line corresponds to the input values, and a bold line corresponds to the obtained values according to the present example.

When the phase image and its line profile obtained according to Comparison Examples 1 and 2 are compared with the phase image and its line profile obtained according to the present example, it can be understood that the phase image closer to the input values can be obtained according to the present example than Comparison Examples 1 and 2.

According to the present example, the intensity information of the end parts of the differential phase image is deleted for each row or each column, but as described in the first exemplary embodiment, the differential phase value may be deleted in units of pixel. In that case, for example, dΦ(x, y)/dx weighted by deleting the right end only in the range displayed to be enlarged in FIG. 7D may be obtained, and dΦ(x, y)/dy weighted by deleting the bottom end only in the range displayed to be enlarged in FIG. 7F may be obtained.

### Example 2

According to Example 2, a more specific example of the second exemplary embodiment will be described by using a simulation result. According to the present example, an example in which the differential phase value in the lightly weighting area is replaced by 0 will be described.

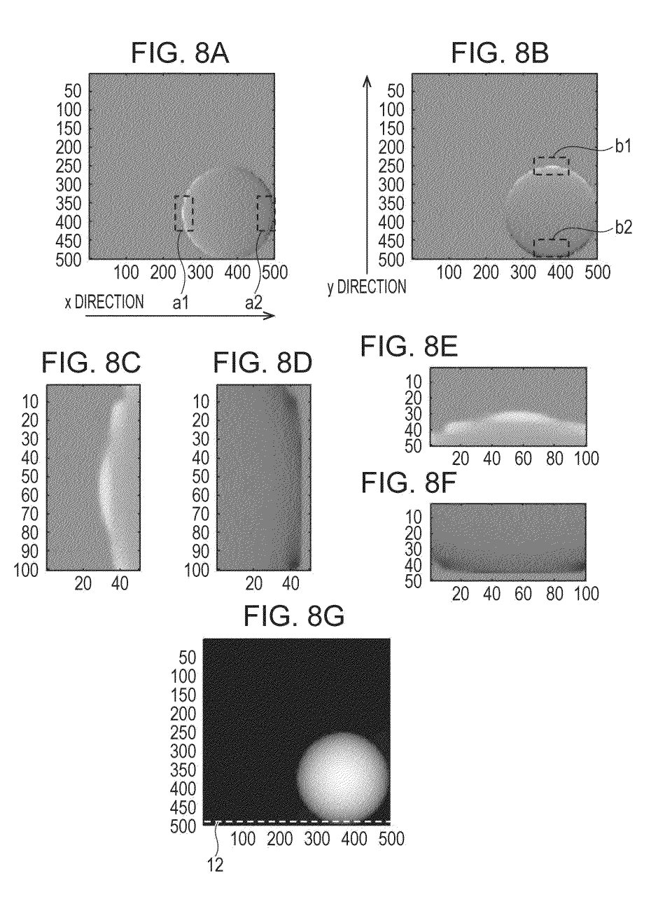

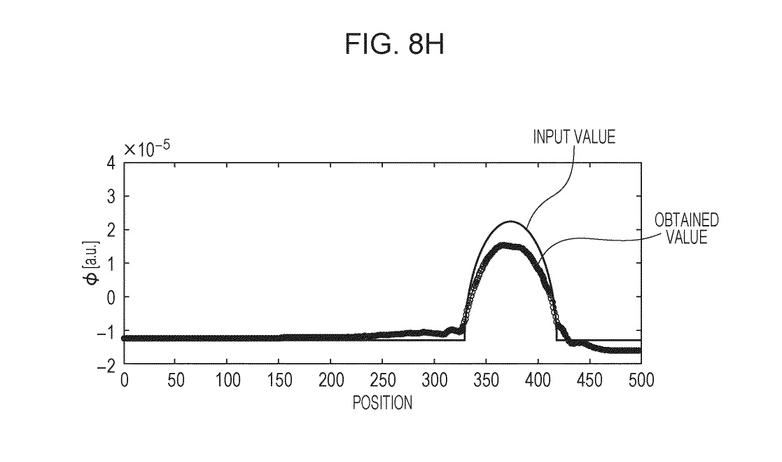

According to the present example, in the differential phase image illustrated in FIGS. 6A and 6B, five rows or five columns each on the top, bottom, left, and right are set as the lightly weighting area, and the weighted differential phase image is obtained by replacing the differential phase values in this area by 0. The weighted differential phase image obtained according to the present example is illustrated in FIGS. 8A and 8B. Similarly as in FIGS. 6A to 6F, FIGS. 8C and 8D are respectively enlarged views in frames a1 and a2 of a dotted line in FIG. 8A. In addition, FIGS. 8E and 8F are respectively enlarged views in frames b1 and b2 of a dotted line in FIG. 8B. The phase image Φ(x, y) is obtained by using the weighted differential phase image obtained according to the present example by employing the same method as Example 1. FIG. 8G illustrates the phase image, and a line profile of the dotted line 12 in FIG. 8G is illustrated in FIG. 8H. In FIG. 8H too, a solid line corresponds to the input values, and a bold line corresponds to the obtained values according to the present example.

When the phase image and its line profile obtained according to Comparison Examples 1 and 2 are compared with the phase image and its line profile obtained according to the present example, it can be understood that the phase image closer to the input values can be obtained according to the present example than Comparison Examples 1 and 2.

According to the present example too, similarly as in Example 1, the replacement of the differential phase value may be performed in units of pixel.

### Example 3

According to Example 3, a more specific example of the third exemplary embodiment will be described by using a simulation result. According to the present example, an example in which the filter is applied to the entire differential phase image will be described.

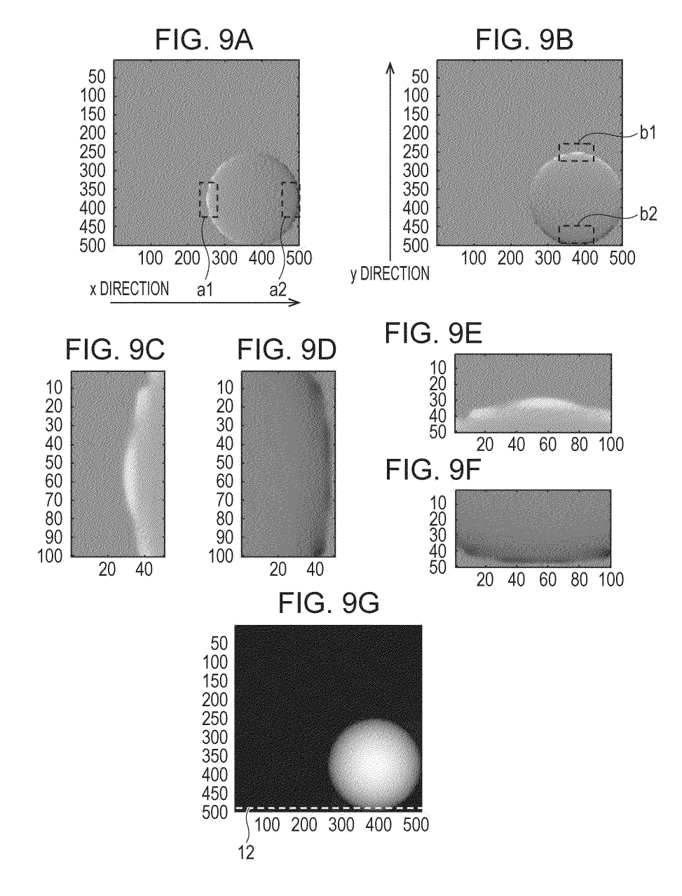

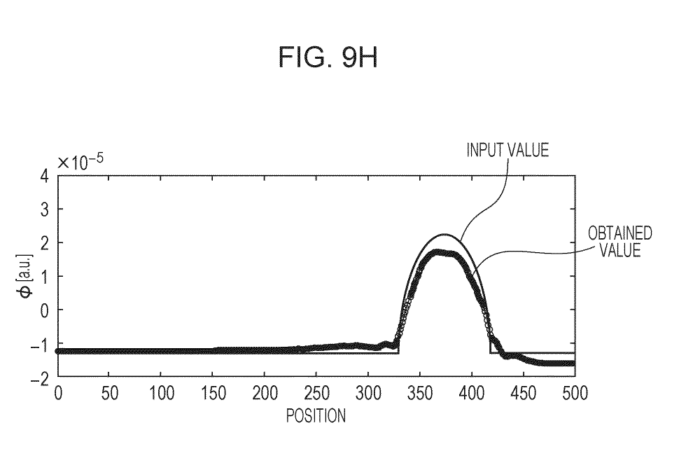

According to the present example, the weighted differential phase image is obtained by applying the filter illustrated in FIG. 11A to the entire differential phase image illustrated in FIGS. 6A and 6B. Five rows or five columns each on the top, bottom, left, and right are set as the lightly weighting area. The weighted differential phase image obtained according to the present example is illustrated in FIGS. 9A and 9B. Similarly as in FIGS. 6A to 6F, FIGS. 9C and 9D are respectively enlarged views in frames a1 and a2 of a dotted line in FIG. 9A. In addition, FIGS. 9E and 9F are respectively enlarged views in frames b1 and b2 of a dotted line in FIG. 9B. The phase image Φ(x, y) is obtained by using the weighted differential phase image obtained according to the present example by employing the same method as Example 1. FIG. 9G illustrates the phase image, and a line profile of the dotted line 12 in FIG. 9G is illustrated in FIG. 9H. In FIG. 9H too, a solid line corresponds to the input values, and a bold line corresponds to the obtained values according to the present example.

When the phase image and its line profile obtained according to Comparison Examples 1 and 2 are compared with the phase image and its line profile obtained according to the present example, it can be understood that the phase image closer to the input values can be obtained according to the present example than Comparison Examples 1 and 2.

According to the present example too, similarly as in Example 1, the replacement of the differential phase value may be performed in units of pixel.

### Example 4

According to Example 4, a more specific example of the third exemplary embodiment will be described by using a simulation result. The present example is different from Example 3 in that the filter is applied to the periodic pattern to obtain the differential phase image. In other words, an example in which the third exemplary embodiment is applied to Comparison Example 1 corresponds to Example 3, and an example in which the third exemplary embodiment is applied to Comparison Example 2 corresponds to Example 4.

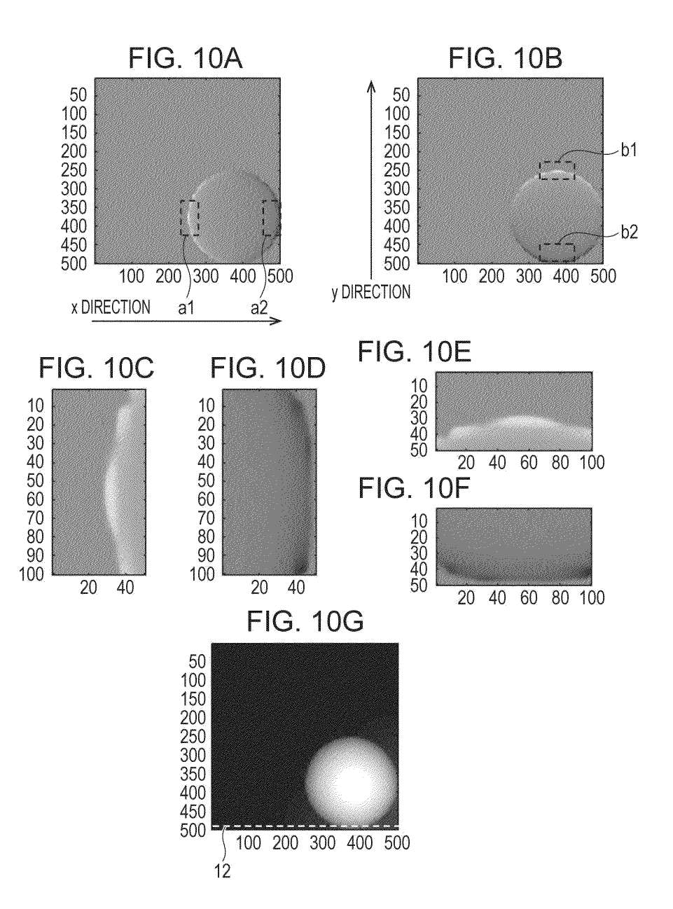

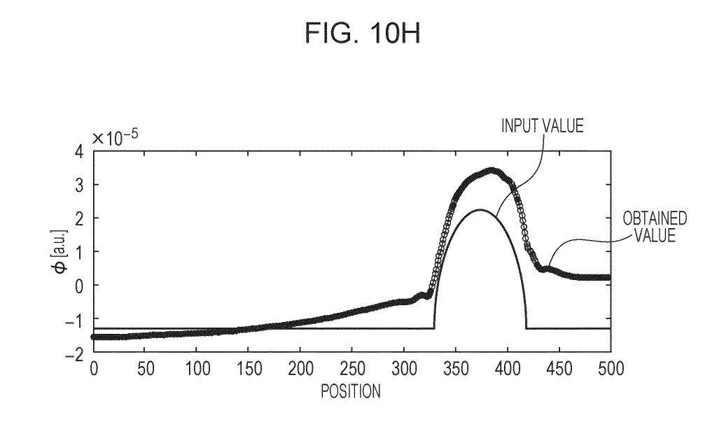

According to the present example, the weighted differential phase image is obtained by applying the filter illustrated in FIG. 11A to the entire differential phase image illustrated in FIGS. 13A and 13B. Five rows or five columns each on the top, bottom, left, and right are set as the lightly weighting area. The weighted differential phase image obtained according to the present example is illustrated in FIGS. 10A and 10B. Similarly as in FIGS. 6A to 6F, FIGS. 10C and 10D are respectively enlarged views in frames a1 and a2 of a dotted line in FIG. 10A. In addition, FIGS. 10E and 10F are respectively enlarged views in frames b1 and b2 of a dotted line in FIG. 10B. The phase image Φ(x, y) is obtained by using the weighted differential phase image obtained according to the present example by employing the same method as Example 1. FIG. 10G illustrates the phase image, and a line profile of the dotted line 12 in FIG. 9G is illustrated in FIG. 10H. In FIG. 10H too, a solid line corresponds to the input values, and a bold line corresponds to the obtained values according to the present example.

When the phase image and its line profile obtained according to Comparison Examples 1 and 2 are compared with the phase image and its line profile obtained according to the present example, it can be understood that the phase image closer to the input values can be obtained according to the present example than Comparison Examples 1 and 2. In this manner, the third exemplary embodiment can be combined with the technology of obtaining the differential phase values close to the input values (original values) since the differential phase image is obtained after the filter is applied to the periodic pattern. It is noted that the first and second exemplary embodiments can also be similarly combined with this technology.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry (ASIC), and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-097149, filed May 8, 2014, which is hereby incorporated by reference herein in its entirety.

What is claimed is:

1. A calculation apparatus that integrates a differential phase image and obtains a phase image, the calculation apparatus comprising:
a weighting unit that performs weighting of a differential phase image that has a plurality of differential phase values, each of the differential phase values being obtained by using intensity information of a plurality of pixels included in one intensity distribution formed by a differential interferometer, and obtains a weighted differential phase image; and
an integration unit that integrates the weighted differential phase image and obtains a phase image,
wherein the weighting unit
performs weighting of the differential phase values in accordance with a position in the differential phase image, and
performs weighting of at least a part of differential phase values in end parts of the differential phase image more lightly than a differential phase value in a central part of the differential phase image.

2. The calculation apparatus according to claim 1,
wherein the weighting unit
obtains the weighted differential phase image by deleting at least a part of the differential phase values in the end parts of the differential phase image from the differential phase image input to the weighting unit, and
outputs the weighted differential phase image to the integration unit.

3. The calculation apparatus according to claim 1,
wherein the weighting unit
obtains the weighted differential phase image by replacing at least a part of the differential phase values in the end parts of the differential phase image in the differential phase image input to the weighting unit by a value having an absolute value lower than the differential phase value, and
outputs the weighted differential phase image to the integration unit.

4. The calculation apparatus according to claim 3,
wherein the weighting unit
performs weighting of at least a part of the end parts in a manner that an average value of absolute values of the lightly weighted differential phase values in the end parts becomes ½ or lower by the weighting, and
obtains the weighted differential phase image.

5. The calculation apparatus according to claim 1,
wherein the weighting unit
obtains the weighted differential phase image by applying a filter to the differential phase image input to the weighting unit, and
outputs the weighted differential phase image to the integration unit.

6. The calculation apparatus according to claim 5, wherein the filter includes a filter with which, when a value of the filter applied to the differential phase value in the central part is set as 1, an average value of values of the filter applied to the lightly weighted differential phase values among the differential phase values in the end parts becomes 0.5 or lower.

7. The calculation apparatus according to claim 1,
wherein the differential phase image includes a differential phase image in an x direction,
wherein the integration unit integrates the weighted differential phase image in the x direction, and
wherein the weighting unit lightly weights a part of pixels in pixel columns arranged in a y direction perpendicularly intersecting with the x direction in the end parts of the differential phase image.

8. The calculation apparatus according to claim 1,
wherein the differential phase image includes a differential phase image in an x direction and a differential phase image in a y direction,
wherein the integration unit integrates the weighted differential phase image in the x direction in the x direction and integrates the weighted differential phase image in the y direction in the y direction, and
wherein the weighting unit lightly weights a part of pixels in pixel columns arranged in the y direction perpendicularly intersecting with the x direction in the end parts of the differential phase image in the x direction and also lightly weights a part of pixels in pixel rows arranged in the x direction in the end parts of the differential phase image in the y direction.

9. The calculation apparatus according to claim 1, further comprising a differential phase image obtaining unit that obtains the differential phase image by using at least the one intensity distribution.

10. The calculation apparatus according to claim 9, wherein the differential phase image is obtained by performing Fourier transform of at least a part of the one intensity distribution.

11. A phase value obtaining system comprising:
a Talbot interferometer or a Talbot-Lau interferometer; and
the calculation apparatus according to claim 9,
wherein the calculation apparatus obtains the differential phase image from an intensity distribution formed by the Talbot interferometer or the Talbot-Lau interferometer.

12. A calculation apparatus that integrates a differential phase image and obtains a phase image, the calculation apparatus comprising:
a weighting unit that performs weighting of a differential phase image that has a plurality of differential phase values, each of the differential phase values being obtained by using intensity information of a plurality of pixels included in one intensity distribution formed by a differential interferometer, and obtains a weighted differential phase image;
an integration unit that integrates the weighted differential phase image and obtains a phase image,
wherein the differential phase image has differential phase values obtained by using intensity information of discontinuous pixels included in the one intensity distribution, and
wherein the weighting unit
performs weighting of the differential phase values obtained by using the intensity information of the discontinuous pixels included in the one intensity distribution more lightly than differential phase values obtained by using only intensity information of continuous pixels included in the one intensity distribution in the differential phase image.

13. The calculation apparatus according to claim 12,
wherein the weighting unit
deletes the differential phase values obtained by using the intensity information of the discontinuous pixels included in the one intensity distribution from the differential phase image input to the weighting unit and obtains the weighted differential phase image, and
outputs the weighted differential phase image to the integration unit.

14. The calculation apparatus according to claim 12, wherein the weighting unit performs the weighting of the differential phase image in a manner that an average value of absolute values of the differential phase values obtained by using the intensity information of the discontinuous pixels in the weighted differential phase image becomes ½ or lower of an average value of absolute values of the differential phase values obtained by using the intensity information of the discontinuous pixels in the differential phase image input to the weighting unit and obtains the weighted differential phase image.

15. The calculation apparatus according to claim 12, wherein the weighting unit performs the weighting of the differential phase image by applying a filter to the differential phase image input to the weighting unit in a manner that, when an average value of values of the filter applied to the differential phase values obtained by using only the intensity information of the continuous pixels is set as 1, an average value of values of the filter applied to the differential phase values obtained by using the intensity information of the discontinuous pixels becomes 0.5 or lower, and obtains the weighted differential phase image.

16. The calculation apparatus according to claim 12, further comprising a differential phase image obtaining unit that obtains the differential phase image by using at least the one intensity distribution.

17. A calculation apparatus that integrates a differential phase image and obtains a phase image, the calculation apparatus comprising:
a differential phase image obtaining unit that obtains a differential phase image by using an intensity distribution; and
an integration unit that integrates the differential phase image and obtains a phase image,
wherein
each of differential phase values of the differential phase image is obtained by the differential phase image obtaining unit by using intensity information of a plurality of continuous pixels in one intensity distribution formed by a differential interferometer, and
the differential phase image obtaining unit does not obtain a differential phase value in an area corresponding to an end part in the one intensity distribution.

18. The calculation apparatus according to claim 17,
wherein,
when the number of plural pieces of continuous intensity information obtained from the one intensity distribution to obtain a differential phase value in a first position is lower than the number of pieces of intensity information necessary to be obtained from one intensity distribution,
the differential phase image obtaining unit does not obtain the differential phase value in the first position.

19. A phase image obtaining method comprising:
weighting a differential phase image that has a plurality of differential phase values, each of the differential phase values being obtained by using plural pieces of intensity information included in one intensity distribution formed by a differential interferometer; and
integrating the weighted differential phase image to obtain a phase image,
the weighting includes
weighting the differential phase values in accordance with a position in the differential phase image, and
weighting at least a part of differential phase values in end parts of the differential phase image more lightly than a differential phase value in a central part of the differential phase image.

20. A phase image obtaining method comprising:
obtaining a differential phase image; and
integrating the differential phase image to obtain a phase image,
wherein, in the obtaining the differential phase image,
each of differential phase values of the differential phase image is obtained by using intensity information of continuous pixels in one intensity distribution formed by a differential interferometer, and
a differential phase value in an area corresponding to an end part in the one intensity distribution is not obtained.
